(19) United States
(12) Patent Application Publication
(10) Pub. No.: US 2020/0303084 A1
(43) Pub. Date: Sep. 24, 2020

(54) RADIATION TOLERANT UNDERWATER CAMERA WITH HIGH DEFINITION VIEWING AND RECORDING CAPABILITY

(71) Applicant: Westinghouse Electric Company LLC, Cranberry Township, PA (US)

(72) Inventors: Shawn D. Lazeski, Latrobe, PA (US); Bryan R. Oehling, Greensburg, PA (US); James T. Polidora, North Huntingdon, PA (US)

(73) Assignee: Westinghouse Electric Company LLC, Cranberry Township, PA (US)

(21) Appl. No.: 16/357,717

(22) Filed: Mar. 19, 2019

(51) Int. Cl. G21C 17/08; H04N 5/225; H04N 5/232

(52) U.S. Cl. CPC G21C 17/08; H04N 5/2252; H04N 5/23216; G21C 19/207; H04N 5/23296; H04N 5/2256; H04N 2005/2255; H04N 5/23299

(57) ABSTRACT

A camera system includes a camera assembly including a camera unit having an optical zoom of at least ×30 and a digital zoom of at least ×10, a controller structured to control one or more operable characteristics of the camera unit and to receive an output of the camera unit, and a conduit connecting the camera unit and the controller.

### BACKGROUND

### 1. Field

The disclosed concept generally relates to cameras, and, more particularly, to underwater cameras for use in nuclear reactor applications.

### 2. Related Art

Monitoring and maintenance is important in the operation of nuclear reactors. Some types of monitoring requires visual inspection of parts of the nuclear reactor. Some parts of the nuclear reactor which need to be visually inspected, such as fuel assemblies, are located in harsh underwater and irradiated environments. The harsh environment presents challenges for performing a visual inspection.

Some prior camera systems have been developed for performing irradiated fuel inspections. Each of the prior camera systems fill a specific role, but lack the capability and versatility to perform full visual exams of fuel assemblies including top and bottom nozzle inspections. For example, some prior low resolution cameras provide a high optical zoom 36:1, but since they are low resolution, they provide poor picture quality. As another example, some prior high definition cameras provide high resolution, but only have a 10:1 optical zoom, and they have dynamic seals that fail over time, causing the cameras to flood.

There is a need for camera systems suitable for performing complete visual inspections of fuel assemblies.

### SUMMARY

Some example embodiments of the disclosed concept provide a radiation tolerant, underwater camera system that can display and record high definition images with an ×36 optical zoom. This system may include external digital and analog high definition outputs including a native serial digital interface (SDI) signal, high definition multimedia interface (HDMI), component video, composite video, and open network video interface forum (ONVIF) video output.

In accordance with an aspect of the disclosed concept, a camera system comprises: a camera assembly including a camera unit having an optical zoom of at least ×30 and a digital zoom of at least ×10; a controller structured to control one or more operable characteristics of the camera unit and to receive an output of the camera unit; and a conduit connecting the camera unit and the controller.

In accordance with another aspect of the disclosed concept, a method of inspecting a fuel assembly of a nuclear reactor is provided. The method comprises: providing a camera system comprising: a camera assembly including a camera unit having an optical zoom of at least ×30 and a digital zoom of at least ×10; a controller structured to control one or more operable characteristics of the camera unit and to receive an output of the camera unit; and a conduit connecting the camera unit and the controller; capturing images of the fuel assembly with the camera assembly; and viewing or storing the captured images with the controller.

### BRIEF DESCRIPTION OF THE DRAWINGS

A further understanding of the invention can be gained from the following description of the preferred embodiments when read in conjunction with the accompanying drawings in which:

FIG. 1 is an illustration of a camera system in accordance with an example embodiment of the disclosed concept;

FIG. 2 is an illustration of a camera assembly in accordance with an example embodiment of the disclosed concept;

FIG. 3A is an isometric view of a camera housing in accordance with an example embodiment of the disclosed concept;

FIG. 3B is a front view of the camera housing of FIG. 3A;

FIG. 3C is a cross-sectional view of the camera housing of FIG. 3B;

FIG. 4A is an illustration of a controller in accordance with an example embodiment of the disclosed concept;

FIG. 4B is a view of a connection panel of the controller of FIG. 4A; and

FIG. 5 is a schematic diagram of a camera system in use in accordance with an example embodiment of the disclosed concept.

### DESCRIPTION OF THE PREFERRED EMBODIMENT

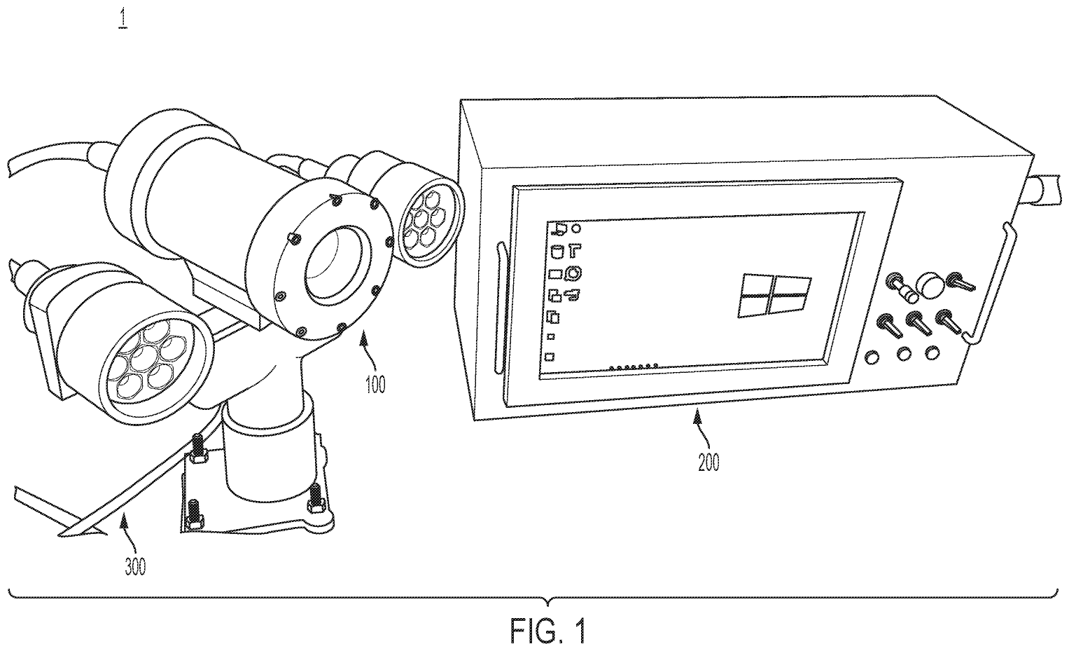

FIG. 1 is an illustration of a camera system 1 in accordance with an example embodiment of the disclosed concept. The camera system 1 includes a camera assembly 100 and a controller 200, as well as one or more conduits 300 connecting the camera assembly 100 to the controller 200.

The camera system 1 is structured such that the camera assembly 100 can be located in and operate in a harsh environment, such as an underwater and irradiated environment as would be found in the vicinity of a fuel assembly of a nuclear reactor. The controller 200 may be located outside the harsh environment with the conduit 300 connecting the camera assembly 100 to the controller 200. Signals and data may be sent between the camera assembly 100 and the controller 200 via the conduit 300.

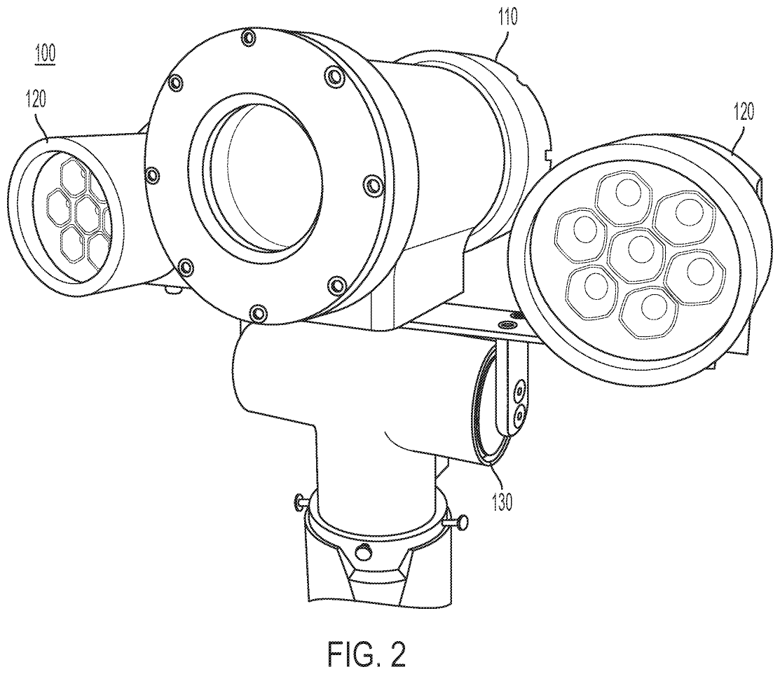

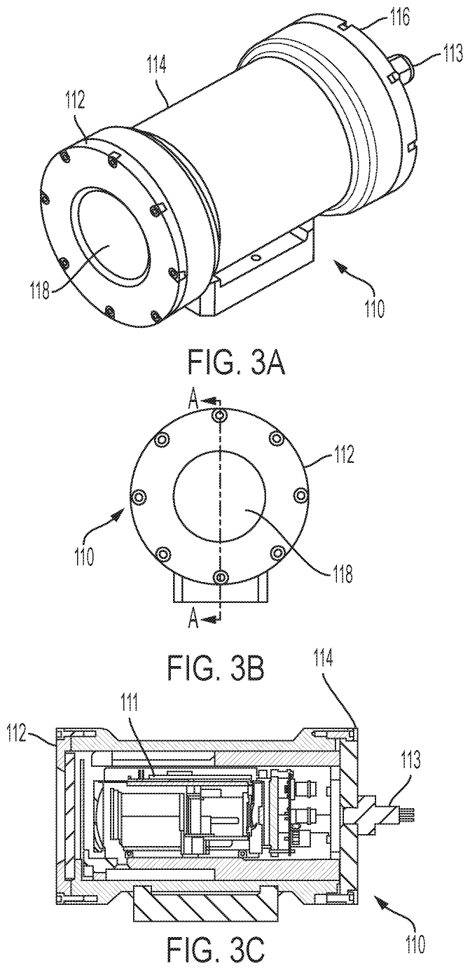

FIG. 2 is an illustration of the camera assembly 100 in accordance with an example embodiment of the disclosed concept. FIG. 3A is an isometric view of a camera housing in accordance with an example embodiment of the disclosed concept, FIG. 3B is a front view of the camera housing of FIG. 3A, and FIG. 3C is a cross-sectional view of the camera housing of FIG. 3B. The camera assembly 100 includes a camera housing 110, lighting units 120, and a pan/tilt unit 130.

The camera housing 110 includes a front cover 112, a body 114, and a back cover 116. A camera unit 111 is housed within the camera housing 110. The camera housing 110 also includes a connector 113, which can be used to connect the conduit 300 to the camera unit 111 located within the camera housing 110. The front cover 112 includes a transparent window 118 such that the camera unit 111 located within the camera housing 110 can capture images of objects exterior to the camera housing 110. The transparent window 118 may be a diopter.

The camera unit 111 is structured is structured to capture high definition still and moving images. The camera unit 111 may capture images using a CMOS sensor or other suitable type of sensor for capturing digital images. In some example embodiments, the camera unit 111 is structured to capture high definition still and moving images at a resolution of at least 1080P. The camera unit 111 is structured to provide an optical zoom of at least ×30 and a digital zoom of at least ×10. In some example embodiment, the camera unit 111 is structured to provide an optical zoom of at least ×36, a digital zoom of at least ×30, or both. The camera unit may also have a light sensitivity of at least 0.5 lux. The camera unit 111 may also have auto focus and auto exposure capabilities.

In some example embodiments, the camera unit 110 is structured to output images via a high definition serial digital interface (HD-SDI). The output may be provided through the connector 113. In some example embodiments, the camera unit 111 may be structured to output images via an analog component output.

In some example embodiments, the camera unit 111 is structured to fit within an envelope size of 11″×5″×5″.

In some example embodiments, the camera assembly 100 is able to operate in water depths of up to 50 feet. Also, the camera assembly 100 is structured to operate in water having a temperature in a range from 60° F. through 122° F. In some example embodiments, the camera assembly 100 is structured to be radiation tolerant to 5×10⁴ rads Cobalt-60 equivalent.

The transparent window 118 may be a diopter. In some example embodiments, the diopter can be interchanged easily. For example, the transparent window 118 may be interchanged with a +0.5 diopter, +0.75 diopter, or a +1 diopter to change the focal length of the camera assembly 100.

In some example embodiments of the disclosed concept, the camera assembly 100 has a weight of 10 lbs. or less.

The lighting units 120 are structured to emit light. The lighting units 120 may include any suitable light source such as, without limitation, light emitting diodes (LEDs). In some example embodiments, the lighting units 120 are 120V lights with up to 250 W max output. The lighting units 120 may also be dimmable.

The pan/tilt unit 130 is structured to pan and tilt to control where the camera housing 110 is facing. The controller 200 may control operation of the pan/tilt unit 130 via the conduit 300.

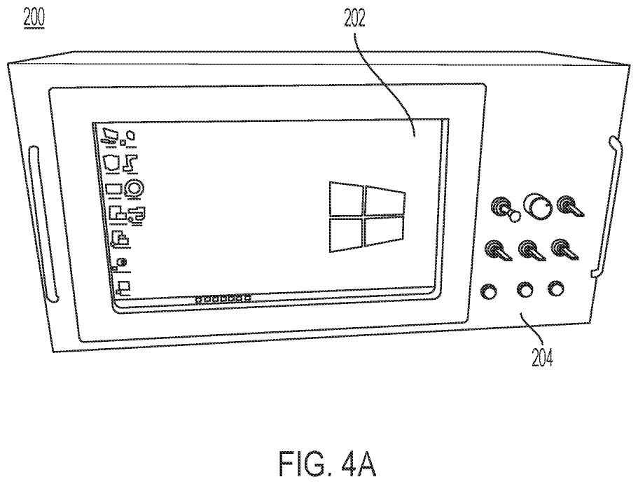

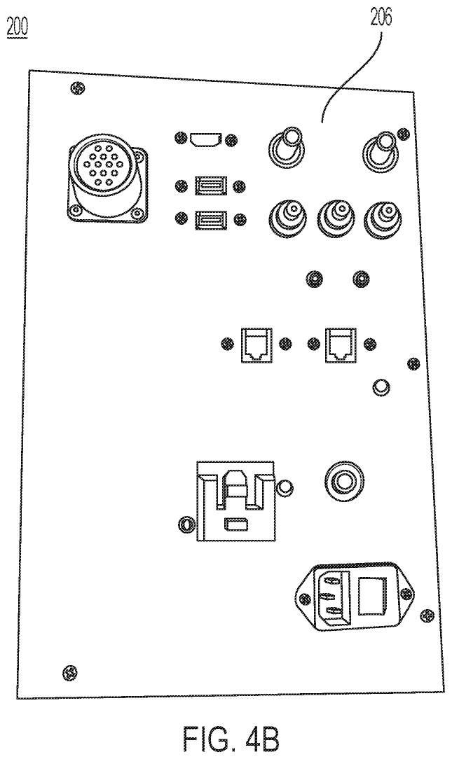

FIG. 4A is an illustration of the controller 200 and FIG. 4B is a view of a connection panel 206 of the controller 200. The controller 200 includes a display 202 and a number of control elements 204 located on its front side. The controller 200 includes a connection panel 206, which may be located on one of its sides, which includes various connectors which may be used to connect the controller 200 to the camera assembly 100 via the one or more conduits 300.

The controller 200 may include a processor and a memory. The processor may implement one or more programs stored on the memory. The memory may also be utilized to store moving or still images received from the camera assembly 100.

The controller 200 is structured to control one or more operable characteristics of the camera assembly 100. In some example embodiments, the controller 200 is structured to control at least one of a zoom, focus, exposure, auto focus, and auto exposure of the camera assembly 100. The controller 200 may also control at least one of pan, tilt, and lighting of the camera assembly 100.

The controller 200 may communicate with the camera assembly 100 using any suitable protocol. In some example embodiments, the controller 200 communicates with the camera assembly ONVIF protocol. When the ONVIF protocol is used, the conduit 300 may be an Ethernet cable. Additionally, in some example embodiments, the controller 200 may be a computer that communicates with the camera assembly 100 via Ethernet. In some example embodiments, the controller 200 communicates with the camera assembly 100 using a video system control architecture (VISCA) protocol. When the controller communicates with the camera assembly 100 using the VISCA protocol, the conduit 300 may be a Serial RS-485 half or full duplex cable. The controller 200 may include one or both of connectors to support Ethernet and Serial RS-485 connections. The controller 200 may also include other types of connectors such as universal serial bus (USB), analog component, composite, SDI, HDMI, power, and audio connectors. The controller 200 may also include a built in circuit breaker and/or ground fault circuit interrupter (GFCI).

The controller 200 is structured to display (via the display 202) and/or store images captured by the camera assembly 100 and communicated to the controller 200 via the conduit 300. The display 202 is able to display the images at a resolution of at least 1080p and, similarly, the controller 200 is able to store the images at a resolution of at least 1080p. In this manner, a user located outside the nuclear reactor may view captured images via the controller 200 to perform a visual inspection of the fuel assembly. In some example embodiments, the controller 200 is also structured to provide integrated high definition video capture with h.264 compression. Also, in some example embodiments of the disclosed concept, the controller 200 is structured to provide text overlay to images displayed on the display 202 and/or in captured and stored images.

The display 202 may be a touch screen display. User inputs may be received via the display 202. The controller 200 may also have physical controls elements 204. The controller 200 is structured such that a user may control one or more characteristics of the camera assembly 100 via the display 202 and/or the control elements 204.

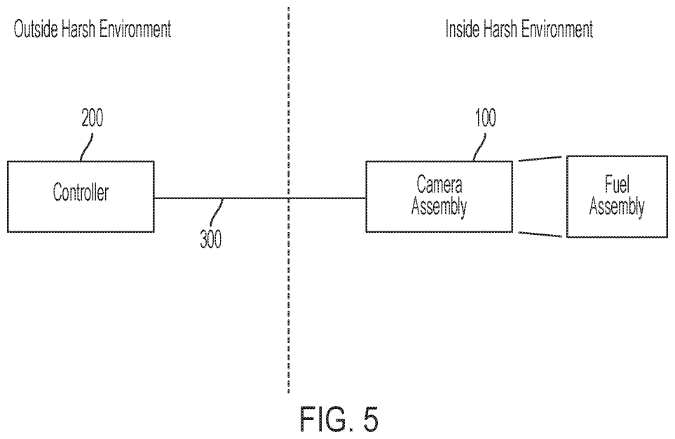

FIG. 5 is a schematic diagram of the camera system 1 in use in accordance with an example embodiment of the disclosed concept. As shown in FIG. 5, the camera assembly 100 is disposed in a harsh environment in the vicinity of the fuel assembly of a nuclear reactor. The camera assembly 100 is connected the controller 200 via the conduit 300 and the controller 200 is located outside the harsh environment. The controller 200 may be used to control operations of the camera assembly 100. The controller 200 may also receive, store, and display data received from the camera assembly 100 such as high definition still or moving images.

In accordance with some example embodiments of the disclosed concept, the disclosed concept may be implemented as a method of inspecting a fuel assembly of a nuclear reactor. In accordance with such a method, the camera system 1 may be provided. The camera assembly 100 may be placed inside the nuclear reactor in the vicinity of the fuel assembly, as shown for example in FIG. 5. The controller 200 may be placed outside the nuclear reactor. The camera assembly 100 may be used to capture images and/or video of the fuel assembly. The controller 200 may be used to view or store the captured images. In some example embodiments, the controller 200 may also be used to control at least one of a zoom, focus, exposure, auto focus, and auto exposure of the camera assembly 100.

In accordance with example embodiments of the disclosed concept, the camera system 1 is a versatile and durable camera system that is capable of performing full visual inspections of fuel assemblies in nuclear reactors. The particular capabilities of the camera system 1 make it suitable for performing full visual inspections of fuel assemblies in nuclear reactors, which prior camera systems are not suited for.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. A camera system comprising:
a camera assembly including a camera unit having an optical zoom of at least ×30 and a digital zoom of at least ×10;
a controller structured to control one or more operable characteristics of the camera unit and to receive an output of the camera unit; and
a conduit connecting the camera unit and the controller.

2. The camera system of claim 1, wherein the camera unit has an optical zoom of at least ×36 and a digital zoom of at least ×32.

3. The camera system of claim 1, wherein the camera unit has a resolution of at least 1080p.

4. The camera system of claim 1, wherein the camera unit has a light sensitivity of at least 0.5 lux.

5. The camera system of claim 1, wherein the camera assembly includes a pan/tilt unit structured to pan and tilt unit structured to pan and tilt and at least one lighting unit.

6. The camera system of claim 5, wherein the controller is structured to control the pan/tilt unit and the at least one lighting unit.

7. The camera system of claim 1, wherein the camera unit is structured to output images using via a high definition serial digital interface (HD-SDI).

8. The camera system of claim 1, wherein the controller includes a display, and wherein the controller is structured to display images captured by the camera unit at a resolution of at least 1080p.

9. The camera system of claim 1, wherein the camera assembly weighs less than 10 lbs.

10. The camera system of claim 1, wherein the camera assembly includes a housing including a front cover, a back cover, and a body connecting the front cover and the back cover, wherein the housing is structured to house the camera unit, and wherein the front cover includes a transparent member through which the camera unit can see the exterior of the housing.

11. The camera system of claim 10, wherein the transparent member is a diopter structured for use with the camera unit.

12. The camera system of claim 11, wherein the diopter is selected from a +0.5 diopter, a +0.75 diopter, and a +1 diopter.

13. The camera system of claim 1, wherein the camera assembly is structured to operate in water depths of up to 50 feet.

14. The camera system of claim 1, wherein the camera assembly is structured to operate in water temperatures in a range of 60° F. to 122° F.

15. The camera system of claim 1, wherein the camera assembly is structured to have a radiation tolerance of at least 5×10⁴ rads Cobalt-60 equivalent.

16. The camera system of claim 1, wherein the conduit is an Ethernet cable, and wherein the controller and the camera assembly are structured to communicate using an open network video interface forum (ONVIF) protocol.

17. The camera system of claim 1, wherein the conduit is a Serial RS-485 half or full duplex cable, and wherein the camera unit and the controller are structured to communicate using video system control architecture (VISCA) protocol.

18. A method of inspecting a fuel assembly of a nuclear reactor, the method comprising:
providing a camera system comprising: a camera assembly including a camera unit having an optical zoom of at least ×30 and a digital zoom of at least ×10; a controller structured to control one or more operable characteristics of the camera unit and to receive an output of the camera unit; and a conduit connecting the camera unit and the controller;
capturing images of the fuel assembly with the camera assembly; and
viewing or storing the captured images with the controller.

19. The method of claim 18, further comprising:
placing the camera assembly inside the nuclear reactor in the vicinity of the fuel assembly; and
placing the controller outside the nuclear reactor.

20. The method of claim 18, further comprising:
controlling at least one of a zoom, focus, exposure, auto focus, and auto exposure of the camera assembly with the controller.
